(19) United States
(12) Patent Application Publication
(10) Pub. No.: US 2026/0300320 A1
(43) Pub. Date: Oct. 1, 2026

(54) WEIGHTED CONTEXT LOCALIZATION

(71) Applicant: Tellagence, Inc., Oregon City, OR (US)

(72) Inventors: Sharookh Daruwalla, Austin, TX (US); Nitin Mayande, Plain City, OH (US)

(21) Appl. No.: 19/309,957

(22) Filed: Aug. 26, 2025

Related U.S. Application Data
(60) Provisional application No. 63/778,407, filed on Mar. 27, 2025.

(51) Int. Cl. G06F 16/28

(52) U.S. Cl. CPC G06F 16/285

(57) ABSTRACT

Systems and methods for performing weighted context localization include determining a weighting metric based on a distribution of information within a plurality of input summaries. The weighting metric is used, possibly with a user query, to define how to create a summary of the plurality of input summaries. A pruning algorithm may be employed on the plurality of input summaries to remove any summaries and/or data points that fail to meet a predefined criteria or threshold. Finally, a summary of summaries are constructed using a machine learning system, based on the definition and weighting metric. Other embodiments may be described and/or claimed.

### CROSS-REFERENCE TO RELATED APPLICATIONS

This application claims priority to U.S. Provisional Patent Application No. 63/778,407, filed on 27 Mar. 2025, the contents of which are hereby incorporated into this application by reference as if fully set forth herein.

### TECHNICAL FIELD

Disclosed embodiments are directed to machine learning (ML) systems, and in particular to methods for reducing hallucinations in artificial intelligence (AI) systems via weighted context localization.

### BACKGROUND

Machine learning and artificial intelligence (AI) technology continues to evolve into increasingly useful tools that can be applied in a variety of different domains. ML systems include a wide variety of different types of algorithms that may enable a computer system to solve various problems, potentially in an adaptive fashion. ML systems may include statistical algorithms that can extrapolate patterns and/or general behaviors from specific data in a predictive fashion. AI technology, which is a subset or type of ML, includes a variety of different techniques and algorithms, including artificial neural networks (ANN). A subset of ANNs includes generative neural networks which, as the name suggests, can create various types of output based on an input prompt. Types of generative neural networks include large language models (LLMs), such as ChatGPT, and image generators, such as DALL-E, among others. For generally accessible implementations of generative AI systems such as ChatGPT and DALL-E, the systems are typically trained on vast amounts of data relevant to the AI system's operative modality, viz. text, images, etc., that may span a variety of different information domains. Other systems may be trained on more specific domains to form an expertise in a particular area. For example, some LLMs may be trained on social network data to provide predictive expertise on user behavior.

While the underlying implementations can vary, generative AI systems typically receive as input a query, such as a question in the form of one or more textual sentences (where the generative AI system input modality is text) or another appropriate input modality. The query is then fed into an input layer of the generative AI system. Generally speaking, generative AI systems are prediction engines, such that an answer to a query is generated by predicting what a next word, pixel, token, etc. (depending on the generative AI system output modality) would be based on the data set used to train the system and, in some implementations, previous predictions. Some generative AI systems also consider previous queries in providing answers, such as when a user has a “conversation” with the system, asking follow-up questions in response to predictions generated from earlier queries.

As mentioned above, types of generative AI may include image generators, which can create synthetic images of widely different types based upon provided user prompts, as well as synthetic motion video. Some such generative AI can employ the likeness of existing people in creating entirely synthetic images and video. Still other examples of generative AI can include music generation, and multi-modal AI which may be able to generate a variety of different types of media in response to user prompts.

The background description provided herein is for the purpose of generally presenting the context of the disclosure. Unless otherwise indicated herein, the materials described in this section are not prior art to the claims in this application and are not admitted to be prior art by inclusion in this section.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a diagram depicting the block components for a context localization process, according to various embodiments.

FIG. 2 illustrates the hierarchical structure applied to a large corpus of data for summarization, according to various embodiments.

FIG. 3 illustrates how the map-reduce technique is used to generate a summary of a large dataset, according to various embodiments.

FIG. 4 is a flowchart of operations of an example method for employing weighted context localization with a machine learning system, according to various embodiments.

FIG. 5 illustrates a pruning technique to improve the accuracy of a summary of summaries, according to various embodiments.

FIG. 6 is a flowchart of operations of a second example method for employing weighted context localization with a machine learning system, according to various embodiments.

FIG. 7 is a block diagram of an example computer that can be used to implement some or all of the components of the disclosed systems and methods, according to various embodiments.

FIG. 8 is a block diagram of a computer-readable storage medium that can be used to implement some of the components of the system or methods disclosed herein, according to various embodiments.

### DETAILED DESCRIPTION OF ILLUSTRATIVE EMBODIMENTS

Generative AI systems are capable of generating outputs based on training datasets. In the case of LLMs, these training datasets are essentially any corpus that provides combinations of words put together to form sentences. A large amount of training data is usually used to train the models so that they can be used to generate a coherent output to a query provided to them. However, at a fundamental level, these models are typically using probability to predict what word(s) should be generated next. In most cases, this prediction is based on context, which may be supplied with a query and/or as background to a query. In these models, context is usually dependent on the token limit supported by the model, which is essentially the memory the model has to retain information. If the input query or data is longer than the token limit, then the information beyond that may be forgotten/ignored, or de-focused by the model. This is a common problem when dealing with data related to specific domains, e.g. social platforms. Despite these limitations, these models can be indispensable to fields such as Social Data Analytics, with capabilities including, but not limited to, summarization, sentiment analysis, etc. These capabilities can not only provide quick ways to process and digest large amounts of data, but can further be used to understand other macro trends such as public opinion, important issues to a specific generation or demographic which in turn can help stakeholders make informed and prudent decisions.

As mentioned above, generative AI models act as prediction engines. In the case of LLMs, generative models generate a predicted next letter, word, sentence, or other token in response to an input query, weights generated from a training data set and, in some implementations, past predictions and queries, such as where a LLM can engage in a conversational session with a user. Similarly, generative AI for images or video generate predicted patterns of pixels, structures, and/or features in response to an input query. However, one issue of current generative AI models and their predictive nature is the possibility of hallucinations. Hallucinations, which may occur when the AI's training and/or structure result in improper predictions from a given input, are essentially predicted results that are false, incorrect, misleading and/or nonsensical when the model's primary goal is to provide factual information. Hallucinations erode trust in the model to provide truthful and factual responses to a user query. While an AI model or system may be trained on factual data to help achieve a goal of factually-based responses, because it is nevertheless a prediction engine, it can make predictions that are not factually correct. Erroneous answers may depend on a given input query, and how the model is configured to weigh various parts of the query and other relevant data provided to the model's input layer along with the query.

In some scenarios, hallucinations may result from an insufficient training data set and/or insufficient use of the set during the training process (e.g. too few training epochs to achieve an acceptable accuracy rate). Such problems can usually be readily identified and corrected, e.g. by employing a larger and/or more refined training data set, increasing the number of training epochs, etc. However, as described above, in some scenarios hallucinations result from the model's focus mechanism failing to focus or process an input query and/or other query in a manner that aligns with the intent of the person creating the query, thereby resulting in an incorrect interpretation of a given query and/or query context. In such instances, the hallucinations may be addressed by careful construction of the query prompt, commonly known as prompt engineering. Prompt engineering may, in some situations, include supplying additional context to increase response accuracy.

Context, for purposes of a generative AI system or model, can be broadly thought of as any data relevant to a particular query that helps the generative AI correctly interpret the query, particularly when a query may be susceptible to multiple interpretations. For example, some phrases may be used literally or idiomatically, e.g. “I turned red” could mean a person literally turned red, such as from a sunburn, or could be used colloquially to mean the person is embarrassed. Many acronyms may have multiple possible meanings, e.g. asking “What are the FARs?” could be referencing Federal Acquisition Regulations, or Federal Aviation Regulations. Contextual information may allow resolution of these ambiguities. By further way of example, where generative AI is conversational, such as where a user of an LLM can submit follow-up queries in response to a generated answer, the context may include all previously submitted queries along with the corresponding answers from the LLM. In such use cases, the LLM may indicate an ambiguity or assume a particular meaning, and the user may issue a follow-up response clarifying the intended meaning; this exchange forms a context that allows resolution of the ambiguity. By resolving the ambiguity, the LLM is significantly more likely to provide accurate and relevant answers.

However, for the various reasons mentioned above, such as limitations in token buffer or memory, the AI or ML system could evaluate an inaccurate context, which may increase the likelihood of a generative AI system or ML system providing a hallucinated answer. This can occur when the AI or ML system's attention mechanism focuses on the wrong words and/or other incorrect aspects of a given query and any associated context.

User queries can take a variety of forms. While text queries such as used with LLMs are discussed, in some embodiments, input queries may be in forms other than text, such as images, sounds, videos, etc. ML systems may be configured to accept input in a variety of different modalities, such as text, images, or sounds. In some cases, queries may be multi-modal and/or may be complex, viz. comprised of multiple related questions or overlapping concepts. Moreover, such ML systems may be capable of outputting in a modality that differs from the accepted input modalities. For example, a neural network trained and configured to output images may accept text-based prompts as input queries. Such a neural network could accept a text query to generate a picture of mountains and respond by outputting one or more such pictures that are responsive to the text query. Similarly, a neural network may be configured to accept an image as input, and output text information about the picture, such as describing one or more objects within the query image. In other examples, some ML systems may be capable of accepting and/or responding with multiple different modalities.

When a large corpus of data is to be analyzed by an ML system to respond to queries, such as data from a social media system, the data may be broken down hierarchically to help generate summaries, such as by using a map-reduce algorithm. Put simply, a map-reduce algorithm breaks a corpus of data that includes a large number of data points into smaller chunks, such as clusters, which are summarized, effectively reducing the data points of each cluster into a single point. These summaries in turn may be placed into chunks, each of which are summarized, and so forth iteratively until a summary of summaries is generated that effectively summarizes the entire corpus of data. The summary of summaries is generated in response to a user query about the corpus of data. For example, where the corpus of data is information from a social media system, questions requiring summarization for answering may include breakdowns of demographic data, breakdowns of interests, locations of users of the social media system, etc.

However, one possible issue with the map-reduce approach that leads to a summary of summaries is that all data points in the corpus of data are typically treated equally, and so may have equal impact upon the response ultimately provided in response to a query. This may not be desirable, as it may lead to inaccurate responses.

Disclosed embodiments include a weighted context localization method. A weighting metric is used to determine the relative impact a given summary or data points (or subsequent summary of summaries) has in each successive summary, up to the final summary of summaries. In other words, weighting various data points in a cluster affects the summary of the data points (cluster, if summarization to form a cluster is performed), weighting each cluster (which may be summarized or simply a dictionary) affects the resulting story (summary of clusters), weighting each story affects the resulting theme (summary of stories), etc. In embodiments, the weighting metric may be applied across the various summaries to alter the extent to which an ML system being used to analyze and summarize the corpus of data considers a given summary (or data points) when generating a subsequent summary or summary of summaries. The weighting metric may be predetermined, may be based on the nature of a given query, or may be based on other considerations relevant to a given implementation. In some embodiments, an ML or AI system may be used to determine the weighting metric, such as by analysis of a given query.

In some embodiments, pruning may be used to strip out summaries based on various criteria. For example, a cluster formed from a number of data points that is below a predetermined threshold or is below a certain percentage of the total data points for a summary of summaries may be pruned, e.g., ignored or disregarded. In a sense, pruning can be thought of as a form of a weighting metric where some data points are accorded zero weight or impact on the ultimate summary. Other possible embodiments will be discussed herein.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

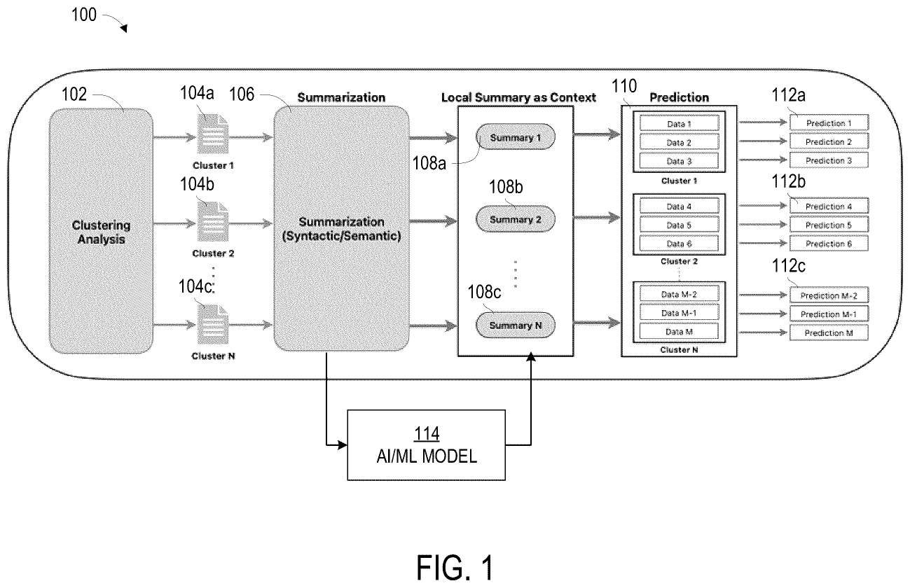

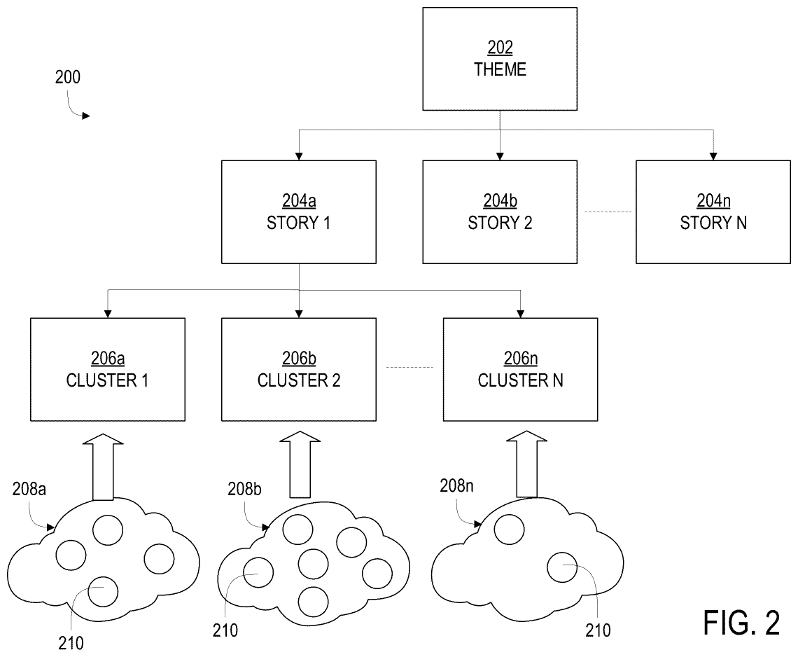

FIG. 1 illustrates the various components of a process flow 100 for a context localization process. As mentioned above, the context localization process may be performed in response to a query, to help ensure the query is correctly understood. Process flow 100 begins with a clustering analysis 102, which results in one or more clusters 104a to 104c. These clusters will be discussed in greater detail below, with reference to FIG. 2. It should be understood that the three illustrated clusters 104a, 104b, and 104c (generically, clusters 104) are merely an example; clustering analysis 102 may result in fewer or more clusters depending upon the nature of the data being processed and the specific requirements of a given implementation. The clusters 104 may then be summarized in a summarization operation 106, resulting in summaries 108a, 108b, and 108c (generically, summaries 108) that are useable as a context for a prompt to a generative AI, such as output predictions 112a, 112b, and 112c. The generative AI (or ML), which may be referred to as a target AI, is an AI or ML model that is used to analyze a corpus of data, and respond to queries about the corpus of data.

In clustering analysis 102, in some embodiments, relevant data points are formatted into similar clusters using one or more clustering algorithms. In embodiments, the clustering algorithms may group data with a similar context together, to drive the generative AI model to focus on the similar context resulting from the grouped data. In embodiments, relevant local data may be obtained from the corpus of data being summarized, where the corpus of data may be formed from one or more themes, discussed below with reference to FIG. 2.

In embodiments, one or more clustering algorithms may be used in conjunction with vector search indices to determine the relevant data from the corpus of local data. Examples of clustering algorithms that may be employed include Hierarchical Small Navigable World (HSNW), k-means, or any other algorithm now known or later developed that is suitable for use with process flow 100 and embodiments disclosed herein. In some embodiments, the clusters 104 may comprise vertices (e.g. data points, as discussed below with respect to FIG. 2) generated from local data embeddings, with each cluster 104 defined as comprising vertices that are within a predetermined threshold of a given target vertex. This helps ensure that the clusters 104a to 104c that are formed are semantically, syntactically, and/or contextually similar. Cluster IDs may then be assigned to each cluster and/or the vertices (or data points) that comprise each cluster. The end result is a series of clusters 104a to 104c that reflect various points of data that may share a similar context, within the corpus of data.

Once the clusters 104a to 104c are determined, in embodiments, they may be summarized in summarization operation 106. As noted in the depicted example in FIG. 1, summarization may involve syntactic analysis, semantic analysis, or a combination of both. Summarization, by definition, is the act of preparing a brief and succinct summary of a much larger corpus. Its primary advantage is that it provides the same pertinent and accurate information as the underlying data, but in a more compact and easily digestible package. For computing purposes, summarization can reduce the required overhead of system resources for processing and so decrease processing time, memory usage, and power consumption.

In some embodiments, the underlying context of each cluster 104 may be individually summarized using a suitable trained or configured AI/ML model 114. All data points within each cluster 104 may be arranged to form a single text data point (or another appropriate input mode if the AI/ML model 114 is so configured), coupled with a carefully designed input prompt, before inputting them into the AI/ML model 114. In some instances, the input to the AI/ML model 114 may comprise a context and a prompt. The context may be the summary of each cluster 104, of all datapoints within that cluster. The carefully designed input prompt may comprise a set of instructions to the AI/ML model 114 on what analysis needs to be performed. In embodiments, the summarization capability of the AI/ML 114 model may use an abstractive approach such that large text/datapoints are converted into a few sentences that capture a context (or most pertinent details) that is seen across the corpus of data.

These sentences (summaries) from the AI/ML model 114 comprise the summaries 108, with each of the summaries 108 corresponding to each of the clusters 104, viz. cluster 104a corresponds with summary 108a, cluster 104b corresponds with summary 104b, etc. Depending upon the functionality of the AI/ML model 114 and/or other components of an implementing system, the various vector representations of the relevant contextual data may be used to obtain the original raw data of the corpus of data, and/or to reference the original data for purposes of generating the summary sentences. It should be appreciated that while the foregoing example contemplates a text mode of input, this disclosure is not intended to be limited to only text-mode based systems. In other embodiments, different modes of entry (e.g. images, sounds, files, etc.) may be utilized. The input prompt(s) and/or the resulting summary may likewise be in a different mode. In still other embodiments, the resulting summary could be in a different mode from the input prompt(s), with the format and mode of the resulting summary determined by the requirements of the target generative AI system.

In embodiments, the summarization pipeline illustrated from clustering analysis 102 to the generated summaries 108 in process flow 100 may be part of a Map-Reduce approach, where a given corpus of data is too large to completely fit within the token limit size of a target AI or ML model, such as a generative AI system. In some such embodiments, the corpus of data is broken down via a hierarchical structure of clusters-stories-themes, which may be based on a predefined token size. This division operation is known as Map. Each hierarchical layer may be summarized iteratively, and the summaries of each layer combined to form a new summary data point. This summarization and combination operation is known as Collapse. The Collapse operation is repeated until the newly generated summary data point(s) is/are reduced into a single summary. This final reduction operation essentially provides a summary-of-summaries and is known as Reduce. The Map-Reduce summarization thus provides a scalable approach, and will be discussed in greater detail with reference to FIG. 2.

Once the various summaries 108 are obtained, they may be used to obtain one or more desired predictions in prediction operation 110. The predictions of prediction operation 110 may be any desired analysis or prediction, such as predictions 112a, 112b, and 112c, that the target ML model is capable of providing. As may be understood, the nature of such predictions may be constrained by the chosen target ML model. For example, in instances where the target ML model is an LLM, the prediction may be a text-based answer to the prompt. Similarly, in instances where the target ML model is an image generator, the prediction may be a desired image, rendered with consideration given to local context. Some possible use cases may also include, but are not limited to, sentiment analysis, summarization, translation, audience targeting, marketing, and the like.

In some specific examples, such as where the contextual data is (or is derived from) social media data, the prediction may be a summarization, or sentiment prediction or analysis, to name a few possibilities. In such an example, sentiment analysis or prediction, at a fundamental level, predicts the sentiment of the underlying information. Sentiment can be as simple as positive, negative, or neutral, or more complex or custom in nature. Predicting summarization and/or sentiment analysis for extremely large datasets, such as raw data feeds from a social media platform, coupled with ever changing communication style, is a non-trivial exercise, even when just for the English language. In the case of social media feeds, sentiment analysis or prediction involves analyzing social platform datasets to extract the underlying sentiment within the dataset interactions. Considering the relatively massive size of raw data from a social media feed, the amount of processing power and time required to perform sentiment prediction on the raw data would be immense, and potentially impossible to accomplish except on relatively high powered systems. However, context localization process flow 100 allows prediction operation 110 to be accomplished with considerably more modest equipment requirements, and/or in a parallel computing configuration, with multiple compute nodes each handling a summary operation.

In examples that are used for sentiment analysis (among other possible uses), summarizing the clusters from summarization operation 106 makes generating a sentiment prediction from the local summaries 108 simpler and accurate. With a carefully designed prompt that incorporates the localized context, instructions and individual data points, as discussed above, all combined as input, prediction operation 110 can generate Positive, Negative, or Neutral sentiment predictions 112a, 112b, and 112c (generically, sentiment predictions 112) for each corresponding local summary 108a, 108b, and 108c. In some embodiments, the sentiment predictions 112 may be generated by passing the carefully designed prompt to AI/ML model 114. In other embodiments, the sentiment predictions 112 may be generated by the target generative AI (which may be a part of AI/ML model 114 in some implementations). Furthermore, in still other embodiments, multiple local summaries 108 may be aggregated to form a single sentiment prediction 112. Along with sentiment predictions 112, the AI/ML model 114 (or target generative AI model if separate) may also provide a detailed explanation of the reasoning used to create the sentiment predictions 112.

FIG. 2 illustrates the hierarchical structure 200 by which a corpus of data is analyzed. The structure is comprised of a theme 202, which in turn may be comprised of a plurality of stories 204a to 204n (collectively or generically, story 204). Each of the plurality of stories 204 in turn may be comprised of a plurality of clusters 206a to 206n (collectively or generically, cluster 206). Each cluster 206 is comprised of a data point cloud such as point cloud 208a to 208n, and each point cloud 208 is comprised of one or more data points 210.

The one or more data points 210 all belong to the corpus of data (also called a dataset). As the data points 210 for the basis of the hierarchy of summaries, one or more themes 202 represent the corpus of data, as they inherently reflect the data points 210. In embodiments, each of the data points 210 is aggregated into their respective point clouds 208. These point clouds 208a, 208b, and through 208n may be considered clusters 206a, 206b, and through 206n (collectively or generically, cluster 206), respectively, in some implementations. In other implementations, the data points 210 in each point cloud 208 may be summarized to form each respective cluster 206. These clusters 206 may be formed from the data points 210, in some embodiments, using both syntactic and semantic similarities, as mentioned above with respect to FIG. 1. In still other embodiments, each cluster 206 may be or may be represented as a dictionary containing at least: 1) A summary of the cluster's contents, which may be textual and/or one or more other modes, as appropriate to the nature of the data and dataset. 2) A volume, which may comprise, for example, a number of social media comments associated with that cluster (in the case of the dataset being a social media feed or database), which can serve as a proxy for the cluster's significance or prevalence. It should be understood that the volume may comprise other types of data points where the dataset is some other type of database, where the other types of data point can likewise serve as a proxy for the cluster's significance/prevalence. 3) A list of salient keywords extracted from the data points from the cluster's comments or summary (or other data types depending on the nature of the dataset).

A group of clusters, here, clusters 206a, 206b, and through 206n, may in turn be summarized, to form a story 204a. In this sense, each of the clusters can be considered a data point that is used to form a given story 204. A group of stories, here, stories 204a, 204b, and through 204n, may similarly be summarized to form a theme 202. As with the clusters, each of the stores can be considered a data point that is used to form the given theme 202. Although not shown, there may be multiple themes 202, which collectively represent the entire corpus of data, including all data points 210. This breakdown of the data points into clusters with hierarchical summarization is a form of map-reduce.

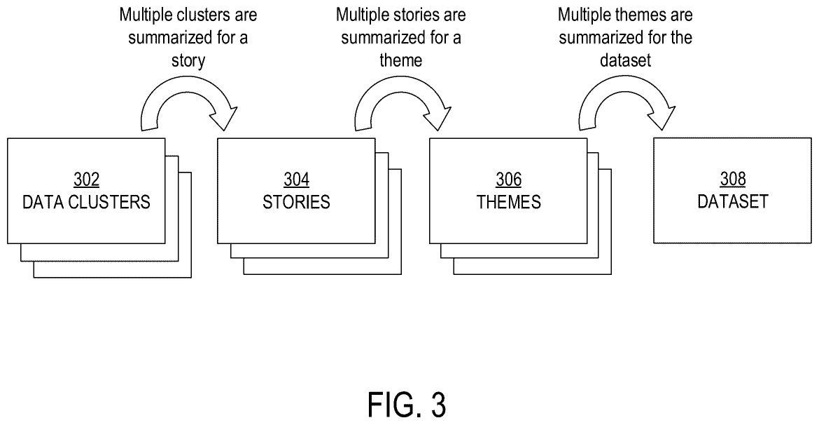

FIG. 3 illustrates in another fashion how a summary of summaries is produced via the map-reduce approach. Similar to as described above with reference to FIG. 2, multiple data clusters 302 are summarized to create each story 304. The clustering algorithm employed to create each data cluster 302 from the underlying data points may group data points together that have a similar context. In this sense, each cluster may form something of a local context for its specific data points.

Multiple stories 304 in turn are summarized to form a theme 306. As with the data points and clusters, the multiple stories 304 may be clustered together to form a given theme 306 on the basis of contextual similarity. As each story 304 derives its context from its constituent clusters 302, each story 304 essentially provides a more general or broader context compared with its lower level components.

Likewise, multiple themes 306 may be clustered to form the dataset 308. When summarized, a summary of summaries that reflects the dataset 308 is obtained. As mentioned above, these summaries may be driven or informed by a user query, which will act to direct how clustering and summarization is performed. In this sense, the user query can be considered as a context to drive the map-reduce and summarization processes.

It should be appreciated that, since the sub-clusters are independent, the AI/ML model 114 (and/or another model or models used to perform clustering and/or summarization) can be configured to run in parallel on the individual sub-clusters.

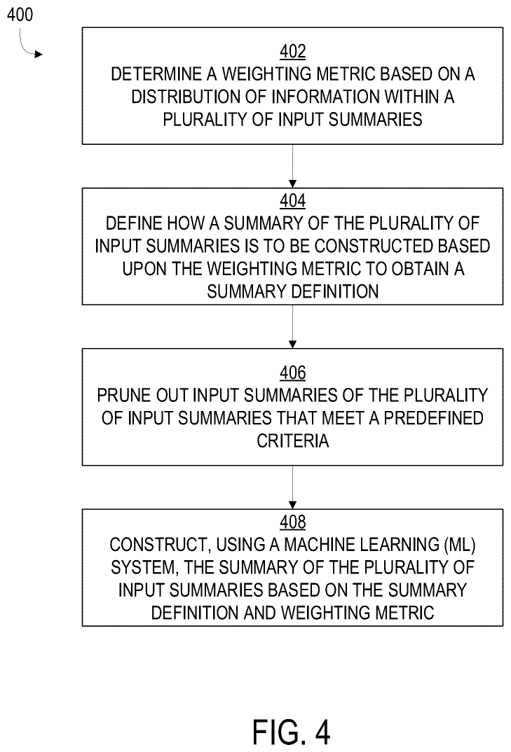

FIG. 4 is an example method 400 of the operations for weighted context localization of a query to a generative AI system. The operations of method 400 may be carried out in whole or in part, depending upon the needs of a given embodiment. Further, some operations may be omitted, some operations may be added, and the order of operations may be rearranged depending upon the requirements of a given embodiment. The operations of method 400 may be carried out by one or more components of a system or process flow such as process flow 100 (FIG. 1). Some or all operations may be carried out by a server, or by a device within the structure, or both. Moreover, some aspects of a given operation may be instead carried out as part of a different operation, depending upon the specifics of a given implementing system.

In operation 402, a weighting metric is determined or identified based on a distribution of information within a plurality of input summaries. As the names suggest, the weighting metric may adjust the relative impact or influence a given component in the hierarchical structure 200 (FIG. 2) has in the summaries further up the hierarchy. For example, the weighting metric may determine the extent to which each individual cluster of data points contributes to or otherwise influences a story formed from multiple clusters of data points. In turn, the weighting metric may determine the extent to which each individual story contributes to or otherwise influences a theme formed from multiple stories, and similarly for how a given theme impacts the summary of summaries for a data set. The same or different weighting metrics may be applied at each different level of the hierarchical structure.

In one possible example, the weighting metric may comprise a percentage distribution for datapoints. Such a relationship may be defined as follows:

$$W . M . ( {C}_{mno} ) = Datapoints ( {C}_{mno} )$$

$$Datapoints ( {S}_{mn} )$$

where Cₘₙₒ are the clusters, and Sₘₙ are stores. When a summary of summaries is generated for a given story Sₘₙ from the summaries of its constituent clusters, the summary of summaries would use each constituent cluster Cₘₙₒ's weighting metric. As can be seen from the foregoing, a cluster Cₘₙₒ that has a higher number of data points relative to the total number of data points of its story Sₘₙ will have a higher percentage, and will be accorded greater weight. This greater weight, in turn, will result in that cluster's unique information having greater inclusion into the summary of summaries for its corresponding story.

Furthermore, where different modalities may be used in the corpus of data and/or in a given query, a different weighting metric may be employed depending upon the given modality. In some implementations, a library of different weighting metrics may be stored in an implementing system. The appropriate weighting metric or metrics to be employed may be selected using an AI or ML model(s), or in any other suitable fashion.

In operation 404, how a summary of the plurality of input summaries is to be constructed to be obtained is defined. In embodiments, this definition is based on the weighting metric determined in operation 402, and may also be based on a user query that directs the types of information sought from the corpus of data, and thus the types of summaries to be generated. For example, the user query may be passed through an ML system to determine and/or select an appropriate weighting metric or metrics. Further, the definition may drive or influence how data points in the corpus of data are formed into clusters for summarization into stories, how the resulting stories may be grouped for summarization into themes, and how the themes may be used to create a summary of summaries.

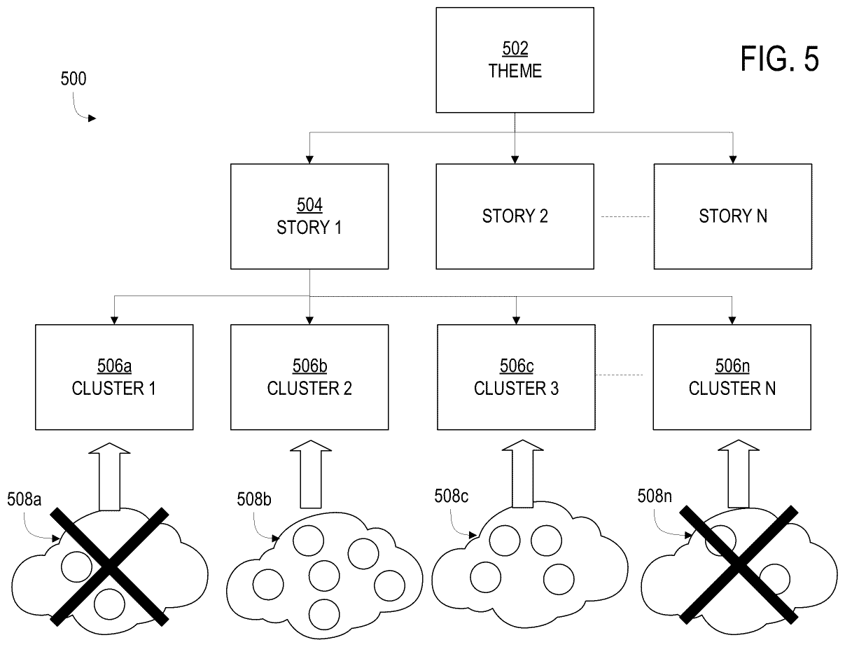

In some embodiments, a pruning operation may be performed. For example, on operation 406, input summaries of the plurality of input summaries that meet a predefined criteria may be pruned out. This predefined criteria may include threshold for a number of data points included in a cluster (or higher level summary), or for clusters that meet a threshold for a percentage of data points included in its corresponding story. The pruning operation will be discussed in further detail below, with respect to FIG. 5.

Finally, in operation 408, a summary of the plurality of input summaries (i.e., the summary of summaries) is generated using a target machine learning system. The summary of summaries is generated by the ML system based on the definition determined in operation 104 as well as the weighting metric.

FIG. 5 illustrates how a pruning operation 500, such as the pruning that may be employed in operation 406 of the method 400 (FIG. 4) may be carried out on a hierarchical structure, such as hierarchical structure 200 (FIG. 2). In the illustrated pruning operation 500, a plurality of data point clouds 508a, 508b, 508c, and through 508n are provided, which correspond to clusters 506a, 506b, 506c, and through 506n. Point cloud 508a has two data points, point cloud 508b has six data points, point cloud 508c has four data points, and point cloud 508n has two data points. A pruning algorithm may comprise a threshold for a number of data points in a cluster, which in this example may be established at three. That is, any cluster with fewer than three data points may be pruned. As can be seen, point clouds 508a and 508n, each with only two data points, are pruned out and thus disregarded. As a result, correspond clusters 506a and 506n are likewise disregarded, with only clusters 506b and 506c used to generate the summary that results in story 504. Effectively, then, pruning is a form of weighting metric that completely eliminates the impact or inclusion of data points in a summary.

As with weighting metrics, different types of pruning algorithms or approaches may be applied at each level of the hierarchical structure. Thus, different pruning criteria may be applied at the story level to determine which stories are summarized to form a theme, and likewise with themes to form a final summary of summaries. Likewise, different pruning algorithms may be employed depending upon the modality of various data points and summaries. A library of pruning algorithms may be created, and/or selection of a pruning algorithm or algorithms may be performed by using an ML or AI system.

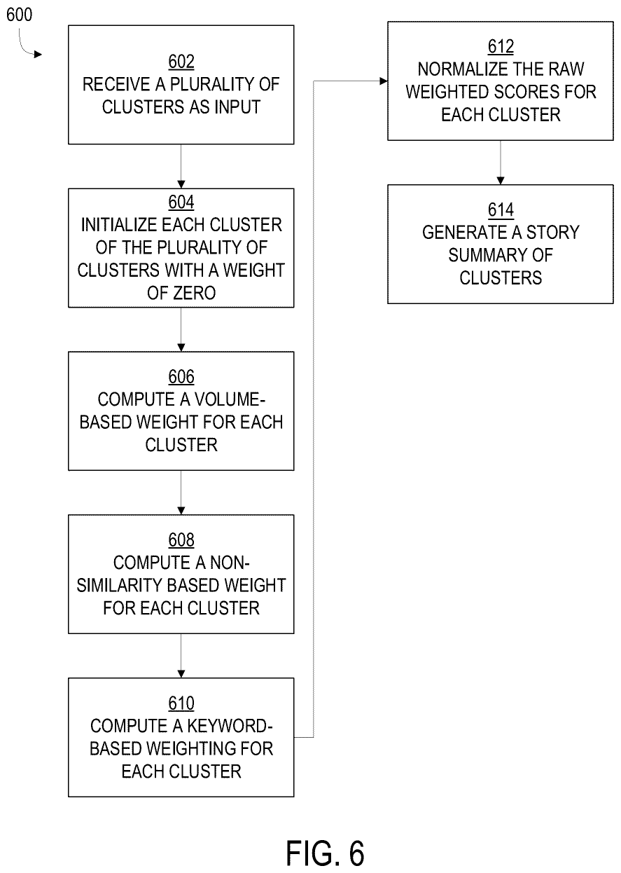

FIG. 6 is an example method 600 of the operations for a second example embodiment for weighted context localization of a query to a generative AI system, which may be applied in some implementations to a dataset such as a social media feed or similar corpus of information. The operations of method 600 may be carried out in whole or in part, depending upon the needs of a given embodiment. Further, some operations may be omitted, some operations may be added, and the order of operations may be rearranged depending upon the requirements of a given embodiment. As with method 400, the operations of method 600 may be carried out by one or more components of a system or process flow such as process flow 100 (FIG. 1). Some or all operations may be carried out by a server, or by a device within the structure, or both. Moreover, some aspects of a given operation may be instead carried out as part of a different operation, depending upon the specifics of a given implementing system.

In operation 602, a collection (or plurality) of clusters are accepted as input, with the plurality of clusters collectively forming a story. Each cluster may be represented as a dictionary, which may contain a summary, a volume, and one or more keywords. In some embodiments, the summary may be a textual summary of the cluster's comments. In other embodiments, the summary may be of one or more different modes (e.g., text, images, sounds, etc.) depending upon the specifics of a given implementation. The volume of each cluster may be the number of social media comments (or other relevant data points where the corpus of data is other than a social media feed) associated with that particular cluster. The number of comments, in such embodiments, can act as a proxy for the cluster's significance or prevalence. For example, if a cluster comprises one or more social media posts, such as may be related to a given topic, the more comments such a cluster may possess or have associated with it, the greater the likely significance of the cluster. This is intuitive, in a sense—subject matter that is highly relevant and/or controversial is likely to attract a relatively large number of comments. The keywords may be a list of salient keywords extracted from the data points from the cluster's comments and/or summary (where the cluster is in a text modality), or may be otherwise extracted or derived from the cluster's content where the cluster has various modalities. If, for example, the cluster includes images, the keywords may be derived via various techniques such as image analysis and object detection.

Once the collection of clusters are accepted as input, in operation 604 raw weights of each cluster are assigned and initialized. Each cluster, in some embodiments, may begin with or otherwise be assigned a raw weight of zero (0). The weight will be subsequently adjusted by accumulation of contributions from various weighting components, discussed below.

In operation 606, each of the clusters is first weighted using volume-based weighting. In embodiments, volume-based weighting prioritizes clusters that represent a larger share of data points within the corpus of data. In implementations involving social media feeds, clusters are prioritized that represent a larger share of the overall social media conversation. In embodiments, volume-based weighting metrics may be calculated for each cluster as follows: First, the total volume of all clusters within a story (Vₜₒₜₐₗ) is calculated. The volume of a cluster, in embodiments, may be a total of the data points in the cluster. For example, for a social media feed, each data point may be an individual comment or post, and the volume of a cluster in the feed would be the numeric total of the comments and posts contained within the cluster. Thus, the volume could be obtained using a simple count function. For other data sources, different types of information may comprise the various data points; obtaining the volume would nevertheless still be accomplished using a count function. Second, for each cluster Cᵢ, a volume-based weight is calculated for each cluster Cᵢ by dividing the individual volume of the cluster (C_{i_volume}) by the total volume Vₜₒₜₐₗ, where i is an integer greater than 0. Third, each volume-based weight may then be multiplied by a hyperparameter α (such as 0.4, or another suitable value), which is used to control the importance of the volume weight and its contribution in the overall weighting of each cluster Cᵢ. Finally, this adjusted volume-based weight is added to the raw weight of its associated cluster Cᵢ.

In operation 608, each of the clusters is next weighted using non-similarity, or diversity, based weighting. Non-similarity based weighting helps ensure that the resulting summary or summaries capture diverse perspectives from the corpus of data, by favoring, e.g. weighting, cluster summary/summaries that are semantically distinct compared to the other clusters. In embodiments, the non-similarity based weighting is computed using semantic embedding, similarity, and a dissimilarity score.

Semantic Embedding: The summary text of each cluster Cᵢ is converted into a high-dimensional numerical vector (e.g., embedding) using a pre-trained model. The pre-trained model, in embodiments, may be a bidirectional encoder representations from transformers (BERT) model. In some particular embodiments, a Sentence-BERT model such as all-MiniLM-L6-v2, which is adept at capturing the contextual meaning of sentences, may be employed. In other embodiments, different models/types of models may be employed depending upon the particulars of a given corpus of data to be processed, such as the nature and modality/modalities of the corpus of data.

Similarity: In embodiments, a similarity is calculated between the embeddings generated by the BERT model for pairs of cluster summaries. A similarity may be generated for the summary of a given cluster Cᵢ based on a similarity between datapoints within the given cluster Cᵢ. The greater the semantic resemblance between the summaries of any two clusters, the higher the resulting similarity. In some embodiments, the similarity may be a cosine similarity. In other embodiments, different types of techniques may be employed to compute a similarity, depending on the needs of a given embodiment.

Dissimilarity Score: In embodiments, for each cluster Cᵢ, a dissimilarity score DSi is computed by subtracting the highest similarity, from the comparison of the summary of cluster Cᵢ against the summaries of all other clusters, from 1. Thus, a cluster that is more dissimilar to all other clusters will have a higher dissimilarity score, with the cluster that is least similar to all other clusters having the highest dissimilarity score.

Once the various factors are computed, in embodiments, the dissimilarity scores are normalized across all clusters. The dissimilarity scores may be normalized using any known process, such as by taking the highest dissimilarity score calculated for a given cluster Cᵢ and dividing all cluster dissimilarity scores by this highest dissimilarity score, such that the highest dissimilarity score is 1. Once normalized, in embodiments, the normalized dissimilarity scores are each multiplied by a hyperparameter β (such as 0.3, or another suitable value) to obtain the non-similarity weight for each cluster Cᵢ. As with the volume-based weights, the hyperparameter β serves to control the relative importance of the non-similarity weight and its contribution in the overall weighting of each cluster Cᵢ. Each non-similarity weight is then added to the raw weight of its respective cluster Cᵢ. Note that in implementations where there is only one cluster, the cluster would inherently be considered maximally diverse.

In operation 610, in embodiments, a keyword-based weighting is next computed for each cluster Cᵢ. The keyword-based weighting emphasizes clusters whose keywords (see operation 602 above) are central to the story's overall topic, and so leverages the distinctiveness of the various keywords. In embodiments, keyword-based weights are computed from story-level keywords, TF-IDF emphasis, and cluster keyword importance scores, as described below.

Story-Level Keywords: A set of story-level keywords are identified, in various embodiments, from keywords that appear frequently, viz. more than once, across multiple clusters comprising the story. The frequency of appearance of a given keyword indicates its general relevance to the story's theme.

TF-IDF Emphasis: In embodiments, a term frequency-inverse document frequency (TF-IDF) vectorizer is applied to the story-level keywords. This results in a score being assigned to each story-level keyword that reflects its importance within a given cluster Cᵢ relative to its frequency across all clusters.

Cluster Keyword Importance Score: In various embodiments, for each cluster Cᵢ an importance score is calculated by summing the TF-IDF scores of the cluster's keywords that were also identified as story-level keywords. Thus, keywords that are both broadly relevant to the story as well as distinctive within their cluster Cᵢ contribute a relatively greater significance, with the significance increasing based on increasing relevance and distinctiveness.

As with non-similarity based weighting, once the various factors are computed, in embodiments, the cluster keyword importance scores are normalized across all clusters. As with the dissimilarity scores, the cluster keyword importance scores can be normalized using any known process, such as by taking the highest keyword importance score found across all clusters, and dividing all the keyword importance scores for all clusters by the highest keyword importance score, so that the highest keyword importance score is 1. Once normalized, in embodiments, the normalized cluster keyword importance scores are each multiplied by a hyperparameter γ (such as 0.3, or another suitable value) to obtain the keyword-based weight for each cluster Cᵢ. As with the volume-based weights and non-similarity weights, the hyperparameter γ serves to control the relative importance of the keyword-based weight and its contribution in the overall weighting of each cluster Cᵢ. Each keyword-based weight is then added to the raw weight of its respective cluster Cᵢ.

As mentioned above, in various embodiments the three hyperparameters α, β, and γ control the relative influence of volume, diversity, and keyword importance, as expressed in the volume-based weighting, non-similarity based weighting, and keyword-based weighting. The sum of these three weights ideally should be 1, in various embodiments. While example values for these various hyperparameters was given above with respect to the various operations, it should be understood that they may be adjusted to achieve various characteristics in the story summaries that are subsequently generated from the clusters. These adjustments may vary depending on the needs of a given embodiment, as well as the nature of the corpus of data being analyzed, and any desired aspects of the generated summaries.

In operation 612, once the three (or more, depending upon the needs of a given embodiment) component weights have been added to the raw weight of each respective cluster Cᵢ, they are normalized. This is accomplished by summing the raw weights of all clusters together, then dividing the raw weight of each respective cluster Cᵢ by this summed total to produce a normalized final weight W_{final} for each cluster. This ensures that the final weights for a given story represented by the plurality of clusters sum to 1.

Finally, in operation 614, a summary of the story represented by the plurality of clusters is generated, in various embodiments, as follows: First, the clusters are sorted in descending order based on their final weights W_{final}. Second, a “long tail” is identified, if one exists. The long tail may be defined in terms of an outlier of some number or threshold percentage (which may be predetermined) of the clusters, such as 80%, or may be defined using any other suitable method now known or later devised. In such an example, the identified long tail can be used to reduce the total number of clusters to be processed and summarized to contribute to the resulting story summary. The long tail may comprise a relatively large number of clusters (identified as those clusters outside the predetermined number or percentage of clusters), which have a very low number of data points compared to clusters within a V_{target}, e.g., clusters that did not get categorized within other, larger, clusters. The clusters forming this long tail may be compressed or otherwise compiled into a single or a few aggregated clusters. In this sense, utilization of a long tail can be considered to be a form or type of pruning, in the same fashion as the pruning techniques described above. It should be understood that, in some implementations, a long tail may not be utilized, and instead all clusters may be summarized, rather than a percentage, e.g. such as when no “long tail” of clusters that comprise a low number of data points exists, viz. all clusters have a comparable or significant number of data points, or the total number of clusters is relatively small, and/or will not impose a significant burden for processing.

Setting a long tail for purposes of pruning can offer several advantages. First, it can help guarantee appropriate coverage of the underlying dataset and corpus of data. By using a sufficiently high percentage for the volume, the resulting summary/summaries can meaningfully represent the corpus of data. The specific percentage that is high enough to obtain a meaningfully representative summary may vary depending on the needs of a given implementation. Second, pruning can resolve long-tail issues. As mentioned above, a long tail in the data may result when the bulk of the corpus of data is found in numerous clusters that each possess only a few data points/a relatively small percentage of the corpus of data, but spread out across many clusters. Processing a long tail will nevertheless allow the summarization process to capture a meaningful amount of the corpus of data, helping to prevent exclusion of portions that are otherwise meaningful simply because they are contained in relatively small clusters. Third, by prioritizing processing of clusters based on weights, use of long tail pruning will nevertheless result in a meaningful summary, even though a portion of the corpus of data may not be considered, because cluster weights are dependent upon volume, diversity, and keyword relevance, and not just based on whether a cluster contains a large amount of data. For example, a cluster with a smaller amount (small volume) of data may be prioritized over a cluster with a large amount (large volume) of data if the cluster with the smaller amount includes unique information not found in other clusters and/or includes keywords that are frequently encountered across the plurality of clusters. In some instances, clusters having slightly more data that is weighted lower may be excluded in favor of clusters having less data but that is higher-weighted if the threshold for defining the long tail is met before reaching the lower-weighted (larger) clusters. As mentioned above, the actual threshold for a long tail selected for a given implementation, or even a given summarization session, may be selected based upon the business requirements of a given implementation/use case and/or the nature of the corpus of data.

Continuing in operation 614 of an example embodiment, next an iterative selection process is employed. In the example embodiment, an empty list selected_summaries, to store summaries chosen for a final story may be initialized, along with a value current_volume_covered, which is set to 0. The sorted clusters are then iterated through starting with those clusters with the highest weighting, then through the clusters in descending weight value, until a threshold number or percentage of clusters above the long tail has been processed. Iteration may be performed by: First, adding the summary of a current cluster Cᵢ to selected_summaries. Next, the volume of cluster Cᵢ is added to current_volume_covered. Finally, iterating is stopped once current_volume_covered/V_{target}≥1, where V_{target} is a threshold defining the long tail. The final summary story may then be generated from the list selected_summaries, which may be provided to an ML system as described elsewhere above.

It should be understood that method 600 may be iterated across successive levels, e.g., each generated final summary story could be one of a plurality of summary stories, which in turn may be fed back to method 600 as input, with each summary story taking the place of the clusters. The resultant summary of the stories would form a theme, which could again be processed through method 600, etc., until a final summary of summaries is generated.

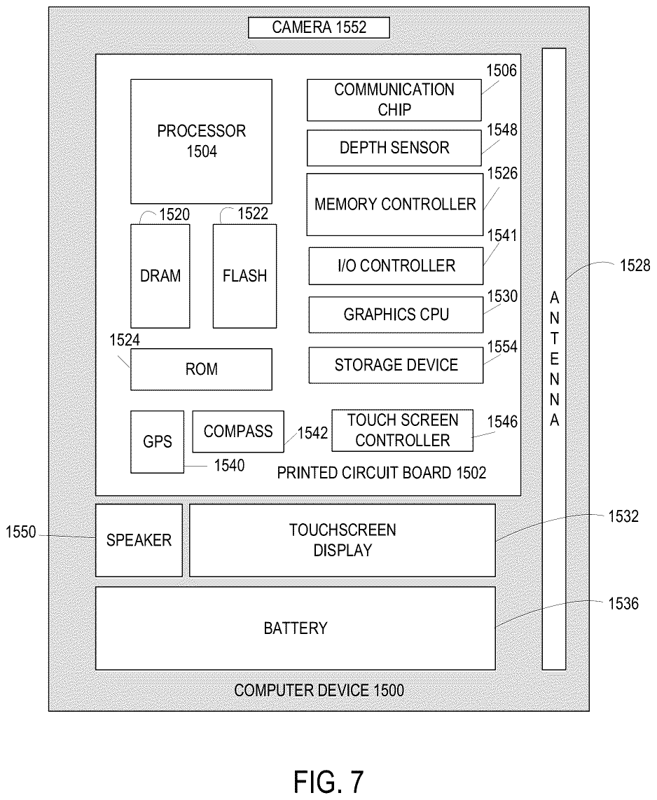

FIG. 7 illustrates an example computer device 1500 that may be employed by the apparatuses and/or methods described herein, in accordance with various embodiments. As shown, computer device 1500 may include a number of components, such as one or more processor(s) 1504 (one shown) and at least one communication chip 1506. In various embodiments, one or more processor(s) 1504 each may include one or more processor cores. In various embodiments, the one or more processor(s) 1504 may include hardware accelerators to complement the one or more processor cores. In various embodiments, the at least one communication chip 1506 may be physically and electrically coupled to the one or more processor(s) 1504. In further implementations, the communication chip 1506 may be part of the one or more processor(s) 1504. In various embodiments, computer device 1500 may include printed circuit board (PCB) 1502. For these embodiments, the one or more processor(s) 1504 and communication chip 1506 may be disposed thereon. In alternate embodiments, the various components may be coupled without the employment of PCB 1502.

Depending on its applications, computer device 1500 may include other components that may be physically and electrically coupled to the PCB 1502. These other components may include, but are not limited to, memory controller 1526, volatile memory (e.g., dynamic random access memory (DRAM) 1520), non-volatile memory such as read only memory (ROM) 1524, flash memory 1522, storage device 1554 (e.g., a hard-disk drive (HDD)), an I/O controller 1541, a digital signal processor (not shown), a crypto processor (not shown), a graphics processor 1530, one or more antennae 1528, a display, a touch screen display 1532, a touch screen controller 1546, a battery 1536, an audio codec (not shown), a video codec (not shown), a global positioning system (GPS) device 1540, a compass 1542, an accelerometer (not shown), a gyroscope (not shown), a depth sensor 1548, a speaker 1550, a camera 1552, and a mass storage device (such as hard disk drive, a solid state drive, compact disk (CD), digital versatile disk (DVD)) (not shown), and so forth.

In some embodiments, the one or more processor(s) 1504, flash memory 1522, and/or storage device 1554 may include associated firmware (not shown) storing programming instructions configured to enable computer device 1500, in response to execution of the programming instructions by one or more processor(s) 1504, to practice all or selected aspects of process flow 100 or method 400 described herein. In various embodiments, these aspects may additionally or alternatively be implemented using hardware separate from the one or more processor(s) 1504, flash memory 1522, or storage device 1554.

The communication chips 1506 may enable wired and/or wireless communications for the transfer of data to and from the computer device 1500. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 1506 may implement any of a number of wireless standards or protocols, including but not limited to IEEE 802.20, Long Term Evolution (LTE), LTE Advanced (LTE-A), General Packet Radio Service (GPRS), Evolution Data Optimized (Ev-DO), Evolved High Speed Packet Access (HSPA+), Evolved High Speed Downlink Packet Access (HSDPA+), Evolved High Speed Uplink Packet Access (HSUPA+), Global System for Mobile Communications (GSM), Enhanced Data rates for GSM Evolution (EDGE), Code Division Multiple Access (CDMA), Time Division Multiple Access (TDMA), Digital Enhanced Cordless Telecommunications (DECT), Worldwide Interoperability for Microwave Access (WiMAX), Bluetooth, derivatives thereof, as well as any other wireless protocols that are designated as 3G, 4G, 5G, and beyond. The computer device 1500 may include a plurality of communication chips 1506. For instance, a first communication chip 1506 may be dedicated to shorter range wireless communications such as Wi-Fi and Bluetooth, and a second communication chip 1506 may be dedicated to longer range wireless communications such as GPS, EDGE, GPRS, CDMA, WiMAX, LTE, Ev-DO, and others.

In various implementations, the computer device 1500 may be a laptop, a netbook, a notebook, an ultrabook, a smartphone, a computer tablet, a personal digital assistant (PDA), a desktop computer, smart glasses, or a server. In further implementations, the computer device 1500 may be any other electronic device that processes data.

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium.

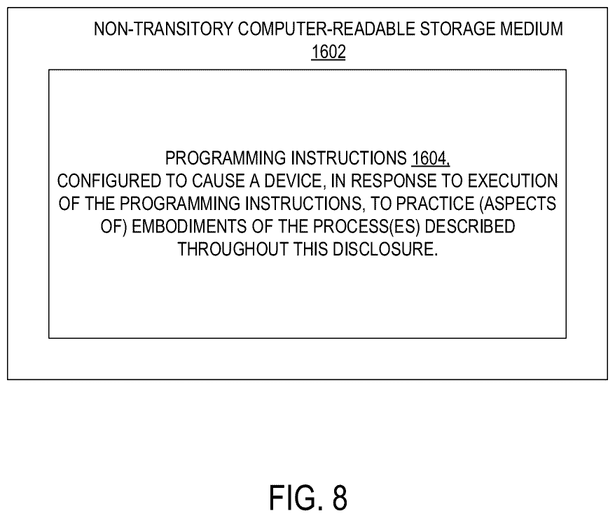

FIG. 8 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 1602 may include a number of programming instructions 1604. Programming instructions 1604 may be configured to enable a device, e.g., computer 1500, in response to execution of the programming instructions, to implement (aspects of) process flow 100 or method 400, described above. In alternate embodiments, programming instructions 1604 may be disposed on multiple computer-readable non-transitory storage media 1602 instead. In still other embodiments, programming instructions 1604 may be disposed on computer-readable transitory storage media 1602, such as, signals.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

1. A method, executed by one or more computing devices, comprising:
determining a weighting metric based on a distribution of information within a plurality of input summaries;
defining how a summary of the plurality of input summaries is to be constructed based upon the weighting metric to obtain a summary definition, wherein each input summary of the plurality of input summaries is weighted according to the weighting metric; and
constructing, using a machine learning (ML) system, the summary of the plurality of input summaries based on the summary definition and weighting metric,
wherein each input summary of the plurality of input summaries is one of a summary of a cluster of data points within a dataset, a summary of a story comprised of a group of clusters, or a summary of a theme comprised of a group of stories.

2. The method according to claim 1, wherein the weighting metric is a percentage distribution.

3. The method according to claim 2, wherein the weighting metric is computed according to:
$$Weight ( {C}_{mno} ) = Datapoints ( {C}_{mno} ) / Datapoints ( {S}_{mn} )$$
wherein Weight (Cₘₙₒ) is a weighting percentage for a given cluster Cₘₙₒ, that determines an amount of data points of a given cluster Cₘₙₒ that are to be used in the summary, Datapoints (Cₘₙₒ) is a number of data points for the given cluster Cₘₙₒ, and Datapoints (Sₘₙ) is a number of data points for a given story Sₘₙ.

4. The method according to claim 1, wherein the weighting metric is defined using information derived from analysis of the dataset.

5. The method according to claim 1, wherein the weighting metric varies based on a modality of each input summary of the plurality of input summaries, or whether each input summary of the plurality of input summaries is a summary of a cluster of data points within a dataset, a summary of a story comprised of a group of clusters, or a summary of a theme comprised of a group of stories.

6. The method according to claim 1, wherein the weighting metric is determined at least in part by using an ML model.

7. The method according to claim 1, wherein defining how a summary of the plurality of input summaries is to be constructed comprises pruning out input summaries of the plurality of input summaries that meet a predefined criteria.

8. The method according to claim 7, wherein the predefined criteria includes pruning out any input summaries of the plurality of input summaries that have fewer data points than a predetermined threshold, or pruning out any input summaries of the plurality of input summaries at a first level that have less than a predefined percentage of the data points of a next higher level.

9. The method according to claim 7, wherein pruning out input summaries of the plurality of input summaries comprises determining which input summaries of the plurality of input summaries to prune using a ML model.

10. The method according to claim 7, wherein pruning out input summaries of the plurality of input summaries comprises employing one or more different pruning algorithms, each selected based on a modality of each input summary of the plurality of input summaries, or selected based on information derived from analysis of the dataset.

11. A non-transitory computer readable medium (CRM) storing instructions that, when executed by one or more processors, cause an apparatus to:
determine a weighting metric based on a distribution of information within a plurality of input summaries;
define how a summary of the plurality of input summaries is to be constructed based upon the weighting metric to obtain a summary definition, wherein each input summary of the plurality of input summaries is weighted according to the weighting metric; and
construct, using a machine learning (ML) system, the summary of the plurality of input summaries based on the summary definition and weighting metric,
wherein each input summary of the plurality of input summaries is one of a summary of a cluster of data points within a dataset, a summary of a story comprised of a group of clusters, or a summary of a theme comprised of a group of stories.

12. The non-transitory CRM according to claim 11, wherein the weighting metric is a percentage distribution.

13. The non-transitory CRM according to claim 12, wherein the weighting metric is computed according to:
$$Weight ( {C}_{mno} ) = Datapoints ( {C}_{mno} ) / Datapoints ( {S}_{mn} )$$
wherein Weight (Cₘₙₒ) is a weighting percentage for a given cluster Cₘₙₒ, that determines an amount of data points of a given cluster Cₘₙₒ that are to be used in the summary, Datapoints (Cₘₙₒ) is a number of data points for the given cluster Cₘₙₒ, and Datapoints (Sₘₙ) is a number of data points for a given story Sₘₙ.

14. The non-transitory CRM according to claim 11, wherein the weighting metric is defined using information derived from analysis of the dataset.

15. The non-transitory CRM according to claim 11, wherein the weighting metric varies based on a modality of each input summary of the plurality of input summaries, or based on whether each input summary of the plurality of input summaries is a summary of a cluster of data points within a dataset, a summary of a story comprised of a group of clusters, or a summary of a theme comprised of a group of stories.

16. The non-transitory CRM according to claim 11, wherein the instructions further cause the apparatus to determine the weighting metric at least in part by using an ML model.

17. The non-transitory CRM according to claim 11, wherein the instructions to cause the apparatus to define how a summary of the plurality of input summaries is to be constructed further cause the apparatus to prune out input summaries of the plurality of input summaries that meet a predefined criteria.

18. The non-transitory CRM according to claim 17, wherein the predefined criteria includes pruning out any input summaries of the plurality of input summaries that have fewer data points than a predetermined threshold, or pruning out any input summaries of the plurality of input summaries at a first level that have less than a predefined percentage of the data points of a next higher level.

19. The non-transitory CRM according to claim 17, wherein the instructions to cause the apparatus to prune out input summaries of the plurality of input summaries further cause the apparatus to determine which input summaries of the plurality of input summaries to prune using a ML model.

20. The non-transitory CRM according to claim 17, wherein the instructions to cause the apparatus to prune out input summaries of the plurality of input summaries further cause the apparatus to employ one or more different pruning algorithms, each selected based on a modality of each input summary of the plurality of input summaries, or selected based on information derived from analysis of the dataset.

21. A method, executed by one or more computing devices, comprising:
receive a plurality of clusters;
initialize each cluster with a raw weight of 0;
determining a weighting metric for each cluster of the plurality of clusters based on information within each cluster of the plurality of clusters;
determining a long tail of the plurality of clusters to be summarized based on the weighting metric for each cluster of the plurality of clusters; and
constructing, using a machine learning (ML) system, a summary of the plurality of clusters based on the weighting metric for each cluster of the plurality of clusters and the long tail,
wherein each cluster of the plurality of clusters is one of a summary of a cluster of data points within a dataset, a summary of a story comprised of a group of clusters, or a summary of a theme comprised of a group of stories.

22. The method according to claim 21, wherein the weighting metric for each cluster of the plurality of clusters comprises a sum of a volume-based weight, a non-similarity based weight, and a keyword-based weight.

23. The method according to claim 21, wherein the long tail comprises a percentage of a total volume of the plurality of clusters.

24. The method according to claim 21, wherein each cluster of the plurality of clusters comprises a summary, a volume, and one or more keywords.

25. The method according to claim 21, wherein determining a long tail of the plurality of clusters to be summarized based on the weighting metric for each cluster of the plurality of clusters comprises:
sorting the plurality of clusters based upon the determined weighting metric for each cluster of the plurality of clusters; and
summarizing each cluster of the plurality of clusters iteratively until a target percentage or threshold of the plurality of clusters is met.
